(19) United States
(12) Patent Application Publication
(10) Pub. No.: US 2007/0176324 A1
(43) Pub. Date: Aug. 2, 2007

(54) Methods of injection molding a polymeric orthopedic device

(75) Inventors: Harold Sparr Taylor, Memphis, TN (US); Thomas A. Carls, Memphis, TN (US)

Correspondence Address: COATS & BENNETT, PLLC, 1400 Crescent Green, Suite 300, Cary, NC, 27518, US

(73) Assignee: SDGI Holdings, Inc.

(21) Appl. No.: 11/342,194

(22) Filed: Jan. 27, 2006

(51) Int. Cl. B29C 45/14; B29C 45/73

(52) U.S. Cl. 264/279; 264/328.1; 264/279.1; 264/327; 264/328.16

(57) ABSTRACT

A method of injection molding an orthopedic device comprising: injection molding a polymeric orthopedic device having a length along a longitudinal axis; and deliberately inducing, in the device, a material property change along the longitudinal axis by varying a molding parameter during the injection molding. The material property may be, for example, elastic modulus and/or density. The molding parameter varied during the injection molding may be a supply material pressure. The orthopedic device may be an elongated rod-shaped element, such as a spinal fixation rod, which may or may not have a substantially uniform cross-section, and may or may not have a metallic core. A corresponding apparatus is also described.

### BACKGROUND

The present application is directed generally to forming orthopedic devices containing polymers, such as spinal implants, and more particularly to methods of injection molding polymeric orthopedic devices.

Orthopedic devices are used to help secure and/or stabilize a variety of bones and related structures. Such devices are typically made from a biocompatible material, especially when the device is intended to be located internal to the body. Biocompatible materials include a variety of metallic materials, such as titanium, and a variety of plastic materials, such as poly-ether-ether-ketone (PEEK). Indeed, polymer materials are considered advantageous for some applications because of their material properties and/or their ability to be easily molded into the desired shape. Molded orthopedic parts are generally molded with uniform material properties within the polymeric material, and changes in mechanical properties are achieved by changing the relevant dimensions of the part. However, it is not always convenient or appropriate to change the relevant part dimensions.

### SUMMARY

One embodiment includes a method of injection molding an orthopedic device comprising: injection molding a polymeric orthopedic device having a length along a longitudinal axis; and deliberately inducing, in the device, a material property change along the longitudinal axis by varying a molding parameter during the injection molding. The material property may be selected from the group consisting of elastic modulus and density. The molding parameter varied during the injection molding may be a supply material pressure. In some embodiments, but not others, the orthopedic device may be an elongated rod-shaped element, such as a spinal fixation rod. The orthopedic device may or may not have a substantially uniform cross-section, and may or may not have a metallic core.

### BRIEF DESCRIPTION OF THE DRAWINGS

FIG. 1 shows an orthopedic device, in the form of a spinal fixation rod, in accordance with one embodiment.

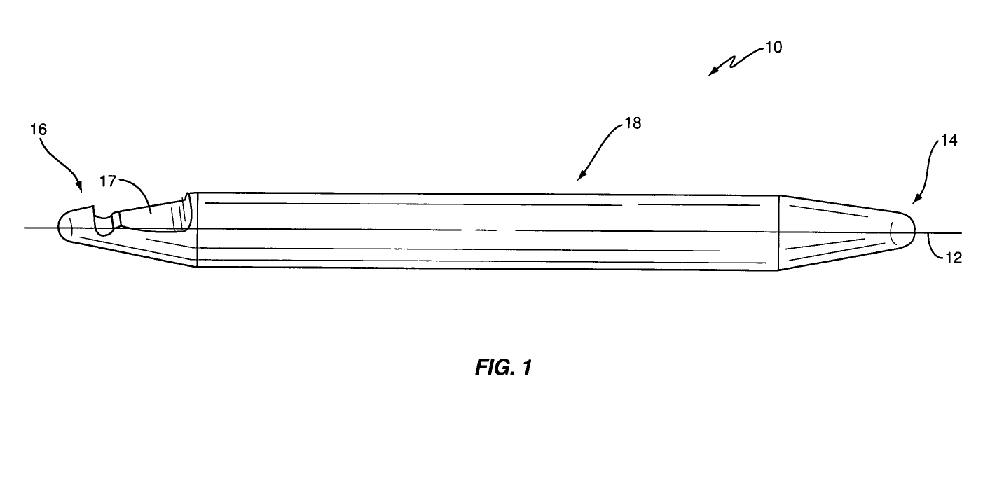

FIG. 2 shows an injection molding apparatus.

FIG. 3 shows a cross-section of a mold, through a mold cavity, just prior to a pressure change.

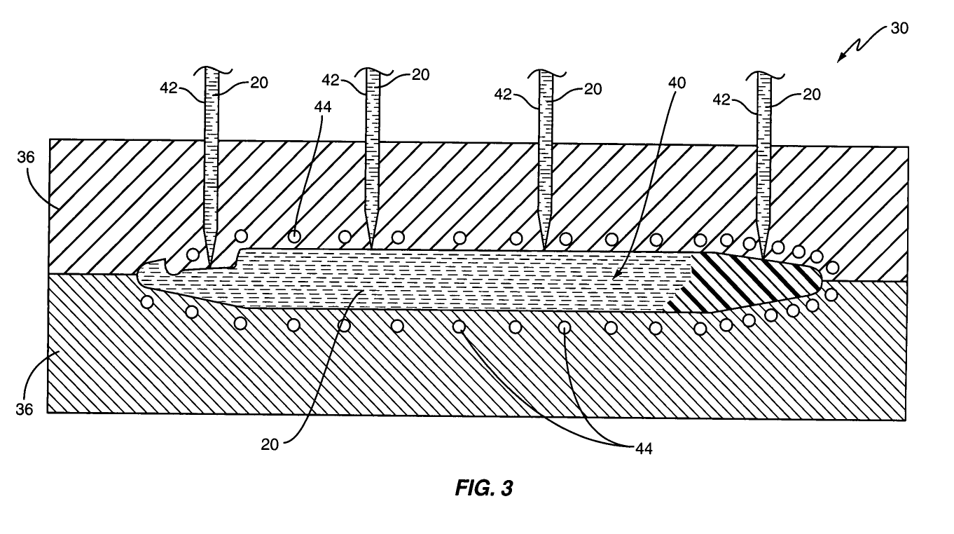

FIG. 4 shows a cross-section of an alternate mold, through a mold cavity, just prior to a pressure change.

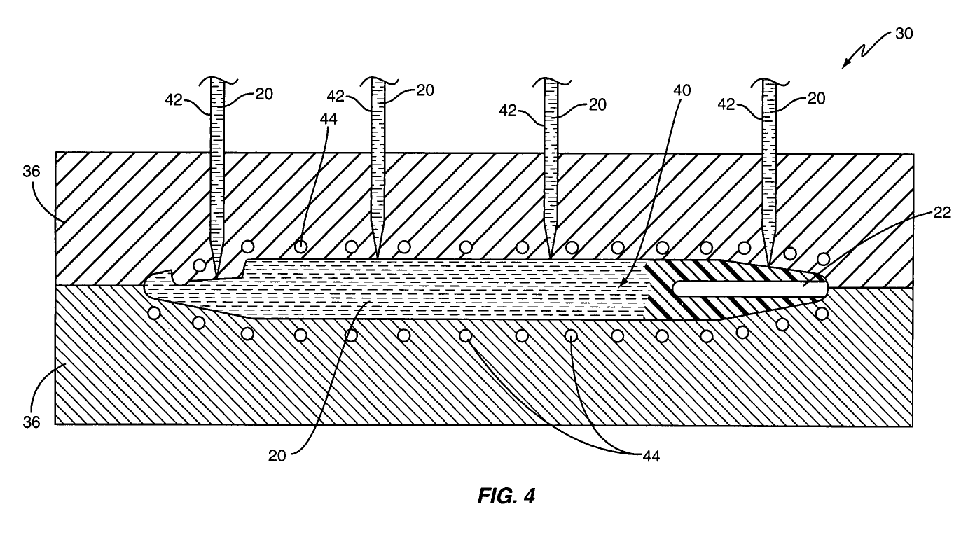

### DETAILED DESCRIPTION

One embodiment relates to methods of injection molding orthopedic devices. For purposes of illustration, the following discussion will be in terms of the orthopedic device 10 being a spinal fixation rod; but it should be understood that other orthopedic devices 10 are within the scope of the present application.

The spinal fixation rod 10 is a generally elongate member that extends along longitudinal axis 12 with respective end portions 14,16 and a central portion 18. The central portion 18 has a generally uniform cross-section, which is optionally circular or oval. The end sections 14,16 taper from the central section 18 to respective rounded tips. One or both of the end sections 14,16 may include notches or other features that aid in installing the rod. For additional details, see U.S. patent application Ser. No. 10/769,569, which is incorporated herein by reference. The spinal fixation rod 10 is formed in whole or in part from an injection-moldable polymer material 20, such as poly-ether-ether-ketone (PEEK).

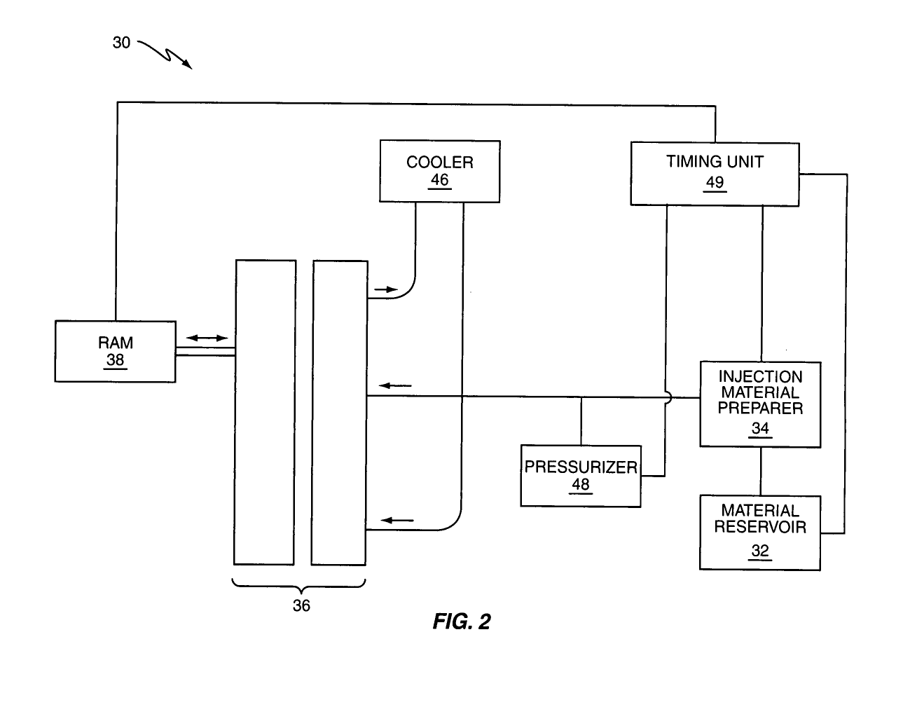

The spinal fixation rod 10 is formed by an injection molding process at an injection molding apparatus 30, such as that shown in FIG. 2. In the injection molding process, the polymeric material 20 is supplied to a mold cavity 32 under pressure. In general terms, the polymeric material 20 fills the mold cavity 40 and then solidifies to form the spinal fixation rod 10. The polymeric material 20 is supplied to the mold cavity 40 from a suitable reservoir 32 via a suitable material preparation apparatus 34, both of a type well known in the art. The polymeric material 20 is supplied to the mold cavity 40 in a pressurized liquid form, typically at an elevated temperature. The polymeric material 20 is injected into to the mold cavity 40 via one or more injection ports 42, typically via suitable nozzles. The mold cavity 40 is typically formed of two large mold bodies 36 of hard material (e.g., tool steel) that are pressed together during the injection phase, and then separate when the part is solidified so that the part may be ejected/removed from the mold cavity 40. Typically, one of the mold bodies 36 is movable via a suitable ram 38, and the other mold body 36 is fixed, although both mold bodies 36 may be moveable if desired.

The mold bodies 36 typically include suitable passages 44 for the routing of cooling fluid therethrough. This cooling fluid is then circulated through a suitable cooler 46 of a type known in the art. This cooling fluid helps cool the injected polymeric material 20 through heat transfer via the metallic mold bodies 36. In one embodiment, the cooling of the polymeric material 20 in the mold cavity 40 is controlled so that one portion of the spinal fixation rod 10 is intentionally cooled more rapidly than another portion, so as to vary a material property of the resulting spinal fixation rod 10. The term “material property,” as used herein, refers to elastic modulus, flexural modulus, density, flexural strength, stress-strain curve, and the like, whether of a homogenous material or of a composite, and excludes geometrical dimensions.

The desired differential cooling rate may be achieved by designing the mold bodies 36 so that the portion of the mold cavity 40 corresponding to end section 14 is served by more cooling fluid passages 44 and/or larger capacity cooling passages 44. Thus, heat may be removed from the polymeric material 20 forming end section 14 faster than from the polymeric material 20 forming central section 18 or end section 16. As end section 14 solidifies, the polymeric material supply pressure is changed (e.g., increased via pressurizer 48), thereby changing the density of the polymeric material 20 in the portions 16,18 of the mold cavity 40 that have not yet solidified. Thus, the polymeric spinal fixation rod 10 can be formed with differing densities for end section 14 relative to end section 16 and/or central section 18. This change in density may be relatively sharp, or may be a smooth gradient. Alternatively, or in addition thereto, and depending on the polymeric material characteristics, the change in pressure may result in a finished spinal fixation rod 10 with a different elastic modulus in the affected sections. Other material properties may likewise be affected. It should be noted that the pressure change may be either an increase or a decrease, with the resulting material property change being likewise either an increase or a decrease.

In another embodiment, the intentional differential cooling may be achieved or assisted by selective timing of the coolant flow through the cooling fluid passages 44 of the mold bodies 36. For example, a timing unit 49 may cause the coolant to flow through the coolant passages 44 corresponding to end section 14, while delaying and/or reducing the coolant flow through the coolant passages 44 corresponding to the central section 18 and/or end section 16.

In another embodiment, the intentional differential cooling may be achieved or assisted by a metallic core element 22 added to the spinal fixation rod 10. For this embodiment, a metallic core element 22 may be disposed in the mold cavity 40 before the polymeric material 20 is added. The metallic core element 22 is mounted from one end of the mold cavity 40, and extends in cantilever fashion toward the other end. Due to the relatively high thermal conductivity of the metallic core element 22, the metallic core element 22 acts as a heat sink internal to the mold cavity 40 that pulls heat from the polymeric material 20 disposed close to it. As such, heat is more quickly pulled from the polymeric material 20 of end portion 14, the end where metallic core element 22 is mounted. Thus, end section 14 of spinal fixation rod 10 should solidify sooner. As in the example above, the injection pressure may be changed when end section 14 solidifies. It should be noted that if, as in some embodiments, end section 14 of resulting spinal fixation rod 10 is not to be hollow, the metallic core element 22 may take the form of an insert that becomes molded into the resulting spinal fixation rod 10. Further, the metallic core element 22 may have a substantially uniform cross-section, or may have a cross-section that varies (e.g., is thicker towards the mounting end), as may be desired.

The various approaches to causing intentional differential cooling of the polymeric material 20 in the mold cavity 40 discussed above may, if desired, be combined in any combination. In addition, while the discussion above has been in terms of end section 14 having a relatively different material property, the material property change may be made in the central section 18, or a selected part thereof, using a similar technique.

The methods described above allow for the spinal fixation rod 10 to have different material properties at different positions along its longitudinal axis 12. Thus, the present methods provide the orthopedic device designer with an option to vary the mechanical characteristics of a polymeric orthopedic device 10 without having to resort to change in geometrical dimensions. Thus, for example, a spinal fixation rod 10 may be made with a relatively uniform cross-section in its central section 18, thereby maximizing the available locations for securing the rod 10 using a single size securing device (e.g., polyaxial screw assembly), but with different mechanical properties due to a deliberately induced variance in material properties. Of course, the change in material properties may be accompanied by a non-uniform cross-section or other change in geometric dimensions, if so desired.

The embodiments disclosed in the present application may, of course, be carried out in other specific ways than those herein set forth without departing from the essential characteristics of the application. The present embodiments are, therefore, to be considered in all respects as illustrative and not restrictive, and all changes coming within the meaning and equivalency range of the appended claims are intended to be embraced therein.

What is claimed is:

1. A method of injection molding an orthopedic device, comprising:
injection molding a polymeric orthopedic device having a length along a longitudinal axis; and
deliberately inducing, in said device, a material property change along said longitudinal axis by varying a molding parameter during said injection molding.

2. The method of claim 1 wherein said material property is selected from the group consisting of elastic modulus and density.

3. The method of claim 1 wherein said varying a molding parameter during said injection molding comprises varying a supply material pressure during said injection molding.

4. The method of claim 3 wherein said varying a supply material pressure comprises lowering said supply material pressure.

5. The method of claim 3 wherein said varying a supply material pressure comprises raising said supply material pressure.

6. The method of claim 1 wherein said injection molding a polymeric orthopedic device comprises injection molding an elongated rod-shaped element.

7. The method of claim 6 wherein said elongated rod-shaped element is a spinal fixation rod.

8. The method of claim 6 wherein said orthopedic device comprises a central section and respective end sections, and wherein said central section has a substantially uniform cross-section.

9. The method of claim 1 wherein said injection molding a polymeric orthopedic device comprises injection molding a polymeric material about a metallic core.

10. The method of claim 1 wherein said injection molding a polymeric orthopedic device comprises injecting polymeric material into a mold cavity and cooling said material at different rates at different points along said longitudinal axis.

11. The method of claim 10 wherein said injecting polymeric material into a mold cavity comprises injecting a homogenous polymeric material into said mold cavity.

12. The method of claim 10 wherein said cooling said material at different rates at different points along said longitudinal axis comprises routing differing amounts of coolant about differing portions of said mold cavity.

13. The method of claim 1 wherein said polymeric material is PEEK.

14. The method of claim 1 wherein:
said material property is selected from the group consisting of elastic modulus and density;
said varying a molding parameter during said injection molding comprises raising a supply material pressure during said injection molding;
said injection molding a polymeric orthopedic device comprises injection molding an elongated rod-shaped spinal fixation rod having a central section and respective end sections, said central section having a substantially uniform cross-section;
wherein said injection molding a polymeric orthopedic device comprises injecting polymeric material into a mold cavity and cooling said material at different rates at different points along said longitudinal axis; and
wherein said injecting polymeric material into a mold cavity comprises injecting a homogenous polymeric material into said mold cavity.

15. The method of claim 14 wherein said injection molding a polymeric orthopedic device comprises injection molding a polymeric material about a metallic core.

16. The method of claim 14 wherein said cooling said material at different rates at different points along said longitudinal axis comprises routing differing amounts of coolant about differing portions of said mold cavity.

17. A method of injection molding an orthopedic device having first and second sections, comprising:
injecting polymeric material into a mold cavity;
causing said polymeric material forming said first section to solidify at a rate faster than said polymeric material forming said second section;
subjecting said polymeric material forming said first section to a first pressure during cooling and subjecting said polymeric material forming said second section to a second pressure during cooling different from said first pressure; and
allowing said polymeric material forming said first and second sections to solidify to form an orthopedic device having one or more different material properties in said first and second sections.

18. The method of claim 17 wherein said allowing said polymeric material forming said first and second sections to solidify to form an orthopedic device comprises allowing said polymeric material forming said first and second sections to solidify to form an elongated rod-like element.

19. The method of claim 17 wherein said causing said polymeric material forming said first section to solidify at a rate faster than said polymeric material forming said second section comprises cooling a first mold section corresponding to said first section at a different rate than a second mold section corresponding to said second section.

20. The method of claim 17 wherein said second pressure is higher than said first pressure.

21. The method of claim 17 wherein said first and second sections have a different density after said solidifying.

22. The method of claim 17 wherein said first and second sections have a different elastic modulus after said solidifying.

23. The method of claim 17 wherein said orthopedic device has first and second end portions and an intermediate portion therebetween, and wherein said second section corresponds to said intermediate portion.

24. The method of claim 17 further comprising disposing a metallic core element in said mold cavity prior to said injecting, and wherein said metallic core element forms a portion of said orthopedic device.

25. The method of claim 24 wherein said disposing a metallic core element in said mold cavity comprises disposing said metallic core element in a section of said mold cavity corresponding to said first section of said orthopedic device.
